(19) United States
(12) Patent Application Publication
(10) Pub. No.: US 2019/0145085 A1
(43) Pub. Date: May 16, 2019

(54) MULTI-FUNCTION PULL HEAD

(71) Applicant: Runner (Xiamen) Corp., Xiamen (CN)

(72) Inventors: LI-ZHONG LIAO, Xiamen (CN); DING-JUN WANG, Xiamen (CN); WEN GAO, Xiamen (CN)

(21) Appl. No.: 16/175,822

(22) Filed: Oct. 30, 2018

(30) Foreign Application Priority Data
Nov. 16, 2017 (CN) 201721528760.5

(51) Int. Cl. E03C 1/04; B05B 1/16

(52) U.S. Cl. CPC E03C 1/0404; E03C 1/0401; E03C 2001/0417; E03C 2001/0415; B05B 1/1609

(57) ABSTRACT

A multi-function pull head comprises a valve seat, and that includes: a water input connector, an outer shell, a water output portion, a first function switching structure, a second function switching structure, and a water output panel. The water input connector is connected onto the outer shell through a thread structure, and two through holes are provided on the outer shell, for the first function switching structure and second function switching structure to pass through respectively. The water input connector is disposed on a top portion of the valve seat. The outer shell is disposed on a bottom portion of the water input connector, to protect the valve seat. The outer shell is engaged to the water input connector through an engaging ring. The water output portion is disposed at a lower portion of the valve seat.

### BACKGROUND OF THE INVENTION

### Field of the Invention

The present invention relates to a pull head, and in particular to a multi-function pull head.

### The Prior Arts

In general, a kitchen faucet pull head (or a pull type faucet) is installed on a fixed type faucet seat. When the kitchen faucet pull head is pulled out, it is detached from the fixed type faucet seat, such that the kitchen faucet pull head can be moved in a larger range area. However, presently on the market, the kitchen faucet pull head water outputting capability is rather limited, it is only capable of outputting shower water or bubble water, thus it can hardly meet the requirement of the user.

Therefore, presently, the design of the kitchen faucet pull head is not quite satisfactory, and it leaves much room for improvement.

### SUMMARY OF THE INVENTION

In view of the problems and drawbacks of the prior art, the present invention provides a multi-function pull head, that is capable of outputting water of flake-shape and sector contour, to increase water output area. As such, dishes washing can be faster and more convenient

In order to achieve the objective mentioned above, the present invention provides a multi-function pull head, comprising a vale seat, and that includes: a water input connector, an outer shell, a water output portion, a first function switching structure, a second function switching structure, and a water output panel. Wherein, the water input connector is disposed on a top portion of the valve seat. The outer shell is disposed on a bottom portion of the water input connector, to protect the valve seat. The outer shell is engaged to the water input connector through an engaging ring. The water output portion is disposed at a lower portion of the valve seat. The first function switching structure and the second function switching structure is disposed onto the outer shell. The water output panel is disposed at a water output end of the valve seat. On the water output panel and from its perimeter to its center is disposed a first water output ring, a second water output ring, and a third water output ring in sequence. On the first water output ring is disposed a first water output hole, on the second water output ring is disposed a second water output hole, and on the third water output ring is disposed a third water output hole. The first water output hole is a shower water output hole, used to output shower water. The second water output hole is a flake-shape sector-contour water output hole, used to output flake-shape sector-contour water. The third water output hole is a bubble water output hole, used to output bubble water. The second water output hole is of a long strip shape, and is disposed in a central line of the water output panel.

In an aspect of the present invention, two second water output holes are disposed symmetrically to each other around perimeter of the third water output hole.

In another aspect of the present invention, a plurality of first water output holes are provided around perimeter of the water output panel with equal spacing between each other.

In yet another aspect of the present invention, the height of the third water output hole protruding out from the water output panel is great than the height of the second water output hole protruding out from the water output panel, while the height of the second water output hole protruding out from the water output panel is great than the height of the first water output hole protruding out from the water output panel.

In a further aspect of the present invention, the opening of the second water output hole is in a plane vertical to an axial line of the valve seat.

In an aspect of the present invention, the multi-function pull head further includes: a first main water channel and a second main water channel, disposed from a water input end to a water output end of the valve seat in sequence. On the first main water channel is disposed a first water diversion channel and a second water diversion channel. The first water diversion channel and a second water diversion channel are disposed at a water output end of the first main water channel. On the connection portion of the first water diversion channel, a second water diversion channel, and the first main water channel is disposed the first function switching structure. On the second main water channel is disposed a straight channel, a first channel, and a second channel. The straight channel, the first channel, and the second channel are disposed at a water output end of the second main water channel. On the connection portion of the straight channel, the first channel, the second channel, and the second main water channel is disposed the second function switching structure.

In an aspect of the present invention, the first water output hole is connected to and in communication with the first channel, the second water output hole is connected to and in communication with the straight channel, and the third water output hole is connected to and in communication with the second channel.

In another aspect of the present invention, the first function switching structure includes a first water tap, a first valve rod, and a first push button. The first push button is disposed at one end of the first water tap, and a top portion of the first valve rod is disposed at the other end of the first water tap. The bottom portion of the first valve rod is disposed in the valve seat through using a first spring.

In yet another aspect of the present invention, on the bottom portion of the first valve rod is disposed a plug, used for blocking the first main water channel to realize connection and communication of the respective water diversion channels, when the first valve rod is moved downward, and a first tight seal ring is disposed on the plug.

In a further aspect of the present invention, the second function switching structure includes a second water tap, a second valve rod, and a second push button. The second push button is disposed at one end of the second water tap, and a top portion of the second valve rod is disposed at the other end of the second water tap. The bottom portion of the second valve rod is disposed in the valve seat through using a second spring.

In an aspect of the present invention, the second tight seal ring is sleeved around the bottom portion of the second valve rod.

In another aspect of the present invention, the water input connector is connected onto the outer shell through a thread structure, and two through holes are provided on the outer shell, for the first function switching structure and second function switching structure to pass through respectively.

Compared with the prior art, the present invention has the advantages in that, it is capable of ejecting flake-shape sector-contour water, to increase range of water ejection, to realize faster and more convenient dish washing. Through providing shower water, bubble water, and flake-shape sector-contour water, the functions of the multi-function pull head can be fully realized, to meet the demand of the user.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is an exploded view of a multi-function pull head according to the present invention;

FIG. 2 is a side view of a water output panel according to the present invention;

FIG. 3 is a bottom view of a water output panel according to the present invention;

FIG. 4 is a cross section view of a multi-function pull head according to the present invention;

FIG. 5 is a cross section view of a multi-function pull head viewed from right side according to the present invention;

FIG. 6(a) is a schematic diagram of a multi-function pull head ejecting out flake-shape sector-contour water according to the present invention;

FIG. 6(b) is a schematic diagram of FIG. 6(a) viewed from right side according to the present invention;

FIG. 7(a) is a schematic diagram of a multi-function pull head ejecting out shower water;

FIG. 7(b) is a schematic diagram of FIG. 7(a) viewed from right side according to the present invention;

FIG. 8(a) is a schematic diagram of a multi-function pull head ejecting out bubble water; and

FIG. 8(b) is a schematic diagram of FIG. 8(a) viewed from right side according to the present invention.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

In the context of the Specification, “an embodiment” or “embodiment” means that it may include specific features, structures, or characteristics for at least one realization way of the present invention. The “in an embodiment” appears in various parts of the Specification does not necessarily mean the same embodiment, nor does it mean a single embodiment, or an embodiment to be mutually exclusive with other embodiments.

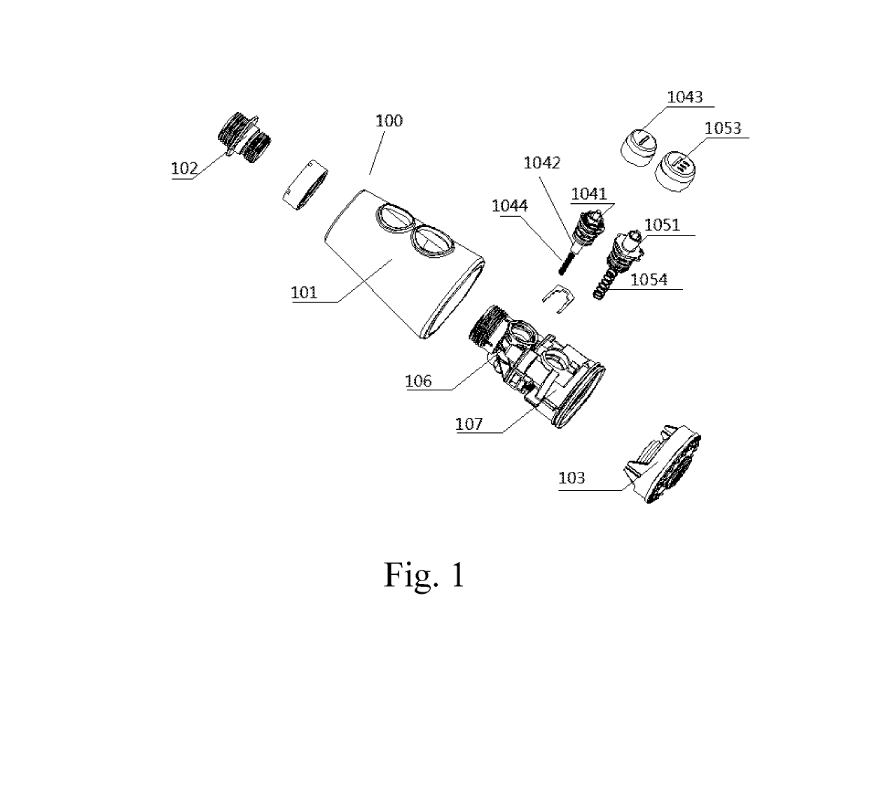

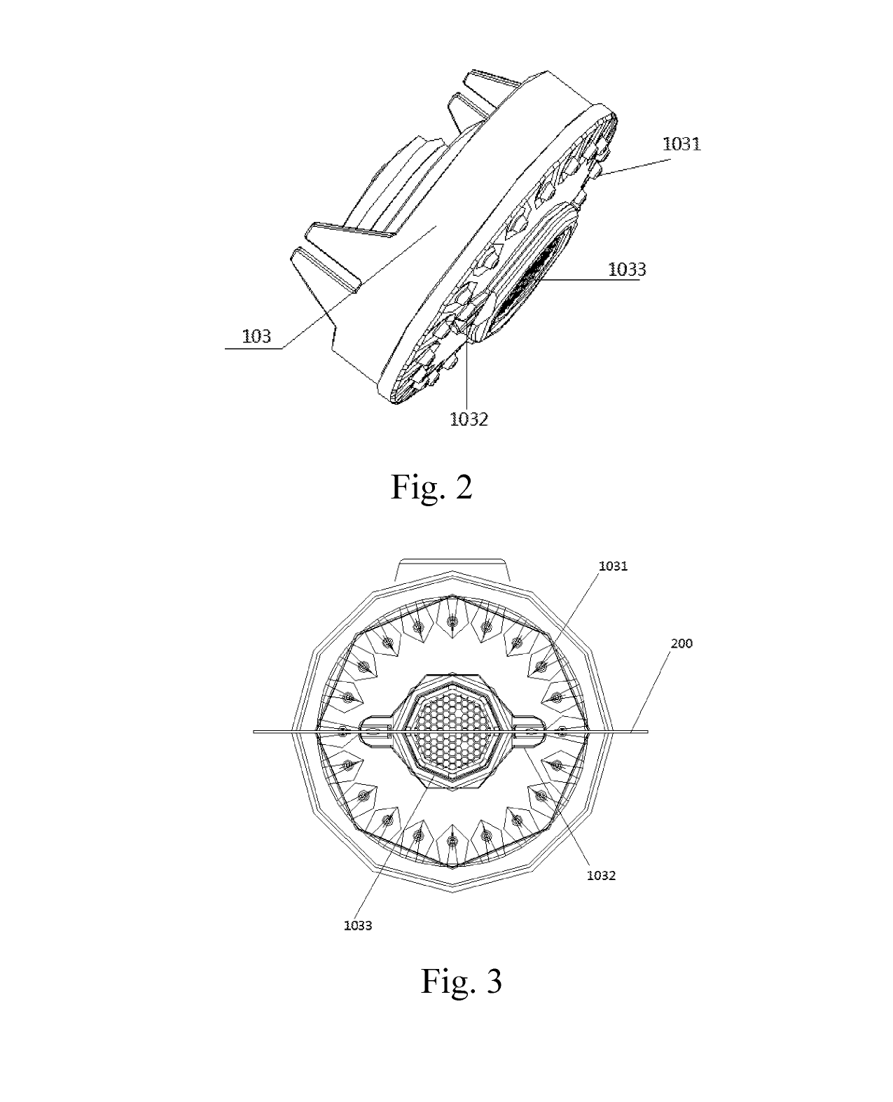

Refer to FIGS. 1 to 3 respectively for an exploded view of a multi-function pull head according to the present invention; a side view of a water output panel according to the present invention; and a bottom view of a water output panel according to the present invention. As shown in FIGS. 1 to 3, the present invention provides a multi-function pull head, comprising a vale seat 100, and that includes: a water input connector 102, an outer shell 101, a water output portion 108, a first function switching structure, a second function switching structure, and a water output panel 103. The water input connector 102 is connected onto the outer shell 100 through a thread structure, and two through holes are provided on the outer shell 101, for the first function switching structure and second function switching structure to pass through respectively.

The water input connector 102 is disposed on a top portion of the valve seat 100. The outer shell 101 is disposed on a bottom portion of the water input connector 102, to protect the valve seat 100. The outer shell 101 is engaged to the water input connector 102 through an engaging ring 105. The water output portion 108 is disposed at a lower portion of the valve seat 100. The first function switching structure and the second function switching structure are disposed onto the outer shell 101.

The water output panel 103 is disposed at a water output end of the valve seat 100. On the water output panel 103 and from its perimeter to its center is disposed a first water output ring, a second water output ring, and a third water output ring in sequence.

On the first water output ring is disposed a first water output hole 1031, on the second water output ring is disposed a second water output hole 1032, and on the third water output ring is disposed a third water output hole 1033. The first water output hole 1031 is a shower water output hole, used to output shower water 300. The second water output hole 1032 is a flake-shape sector-contour water output hole, used to output flake-shape sector-contour water 200. The third water output hole 1033 is a bubble water output hole, used to output bubble water 400.

The second water output hole 1032 is of a long strip shape, and is disposed in a central line of the water output panel 103.

Two second water output holes 1032 are disposed symmetrically to each other around perimeter of the third water output hole 1033.

A plurality of first water output holes 1031 are disposed around perimeter of the water output panel 103 with equal spacing between each other.

The height of the third water output hole 1033 protruding out from the water output panel 103 is great than the height of the second water output hole 1032 protruding out from the water output panel 103, and the height of the second water output hole 1032 protruding out from the water output panel 103 is great than the height of the first water output hole 1031 protruding out from the water output panel 103.

The opening of the second water output hole 1032 is in a plane vertical to an axial line of the valve seat 100.

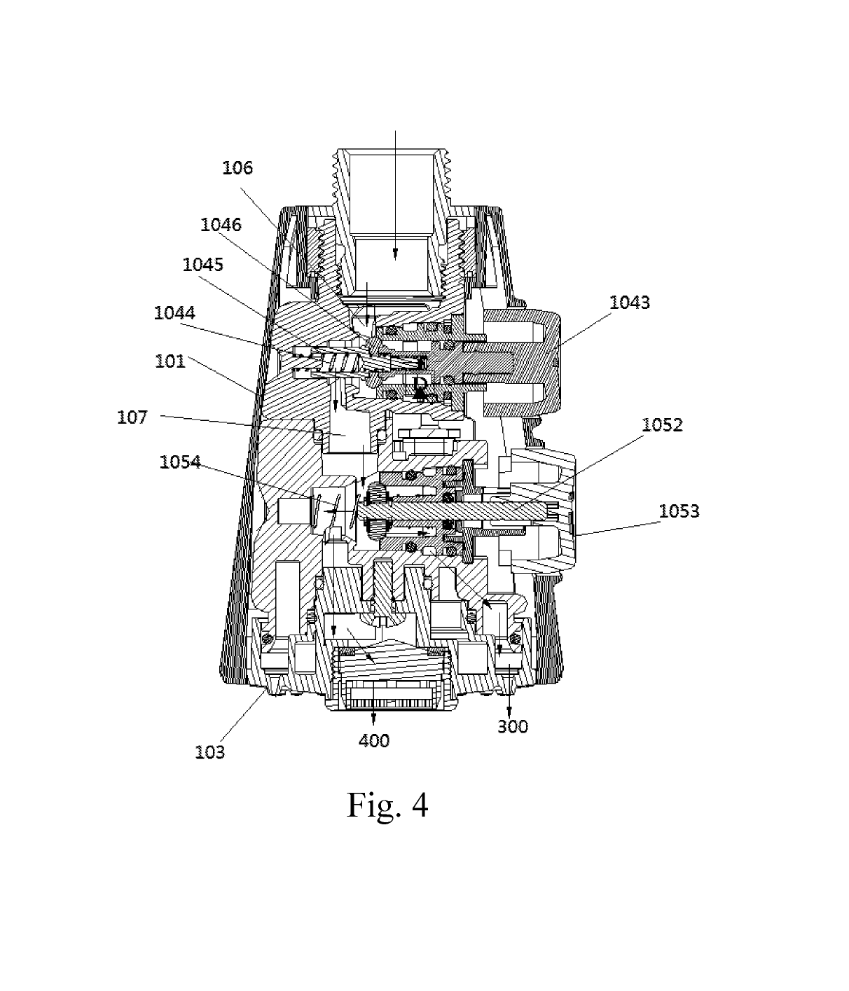

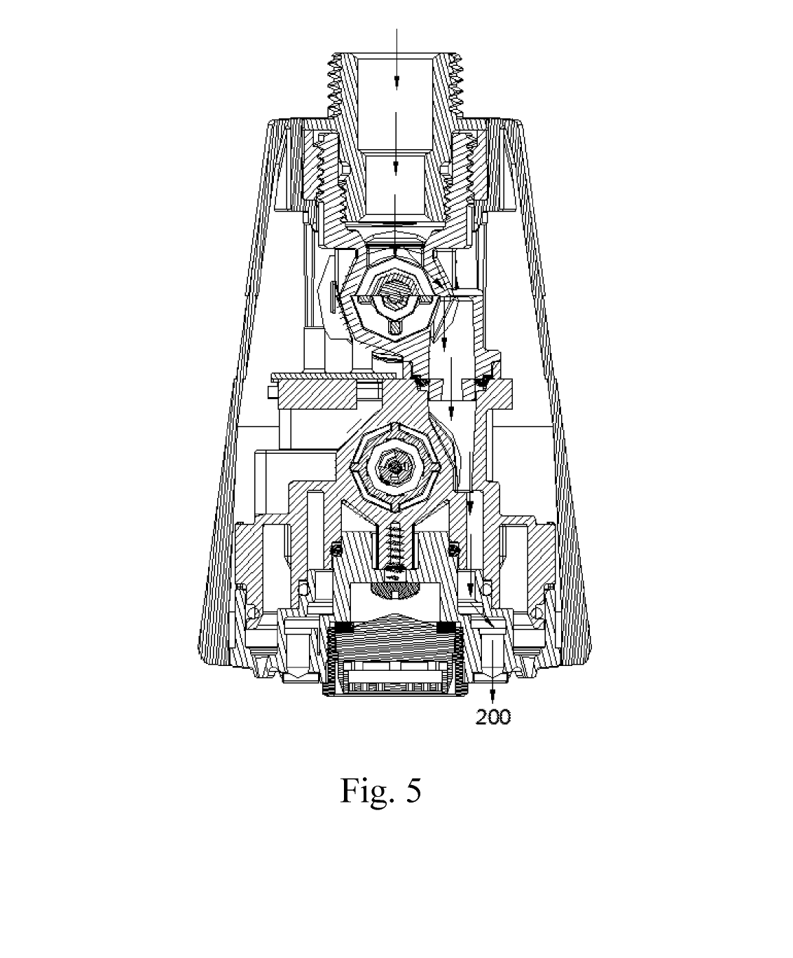

Refer to FIGS. 4 and 5, in which the arrows indicate directions of water flow. As shown in FIGS. 4 and 5, the multi-function pull head further includes a first main water channel 106 and a second main water channel 107, disposed from a water input end to a water output end of the valve seat 100 in sequence. On the first main water channel 106 is disposed a first water diversion channel and a second water diversion channel. The first water diversion channel and a second water diversion channel are disposed at a water output end of the first main water channel 106. On the connection portion of the first water diversion channel, a second water diversion channel, and the first main water channel 106 is disposed the first function switching structure. On the second main water channel 107 is disposed a straight channel, a first channel, and a second channel. The straight channel, the first channel, and the second channel are disposed at a water output end of the second main water channel 107. On the connection portion of the straight channel, the first channel, the second channel, and the second main water channel 107 is disposed the second function switching structure.

The first water output hole 1031 is connected to and in communication with the first channel, the second water output hole 1032 is connected to and in communication with the straight channel, and the third water output hole 1033 is connected to and in communication with the second channel.

The first function switching structure includes a first water tap 1041, a first valve rod 1042, and a first push button 1043. The first push button 1043 is disposed at one end of the first water tap 1041, and a top portion of the first valve rod 1042 is disposed at the other end of the first water tap 1041. A bottom portion of the first valve rod 1042 is disposed in the valve seat 100 through using a first spring 1044.

On the bottom portion of the first valve rod 1042 is disposed a plug 1045, used for blocking the first main water channel 106 to realize connection and communication of the respective water diversion channels when the first valve rod 1042 is moved downward. A first tight seal ring 1046 is disposed on the plug 1045.

The second function switching structure includes a second water tap 1051, a second valve rod 1052, and a second push button 1053.The second push button 1053 is disposed at one end of the second water tap 1051, and a top portion of the second valve rod 1052 is disposed at the other end of the second water tap 1051. The bottom portion of the second valve rod 1052 is disposed in the valve seat 100 through using a second spring 1054. The second tight seal ring is sleeved around the bottom portion of the second valve rod 1052.

The details of the water output principle for the multi-function pull head is explained as follows.

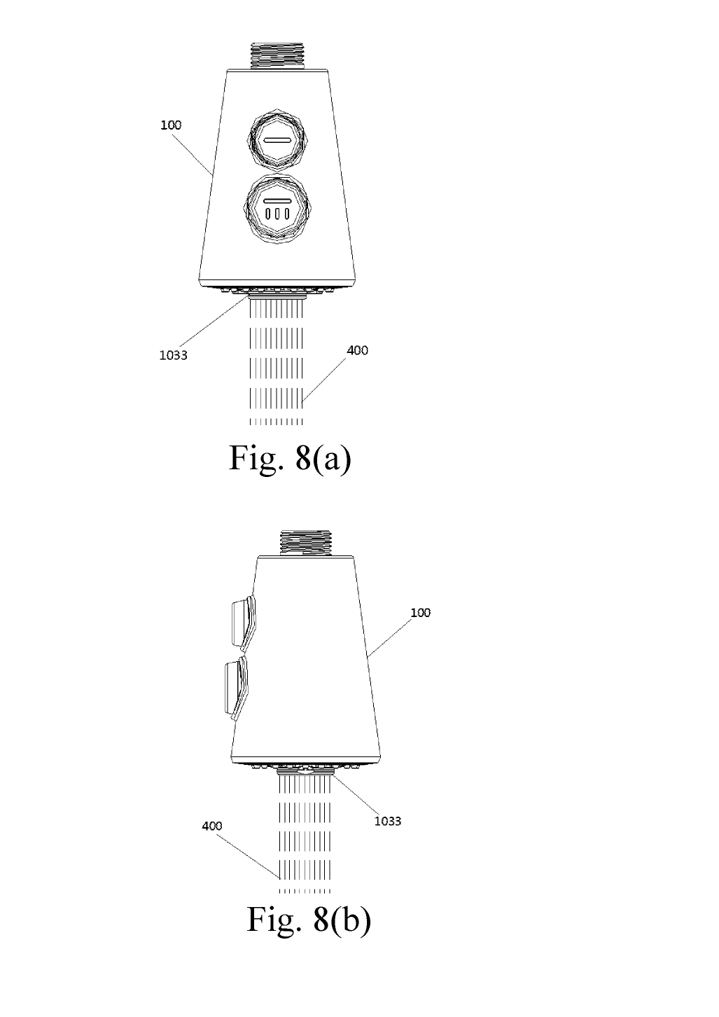

1. Presetting the first function switching structure and the second function switching structure into a relaxed state. As shown in FIGS. 4, 8(a), 8(b), water is input from a water inlet pipe to the first main water channel 106. Then, water flows through the first water tap 1041 into the first water diversion channel, and then to the second main water channel 107. Subsequently, the water in the second main water channel 107 flows into the first channel through the second water tap 1051. Finally, water in the first channel flows into the third water output ring of the water output panel 103, to eject from the third water output hole 33 into the bubble water 400.

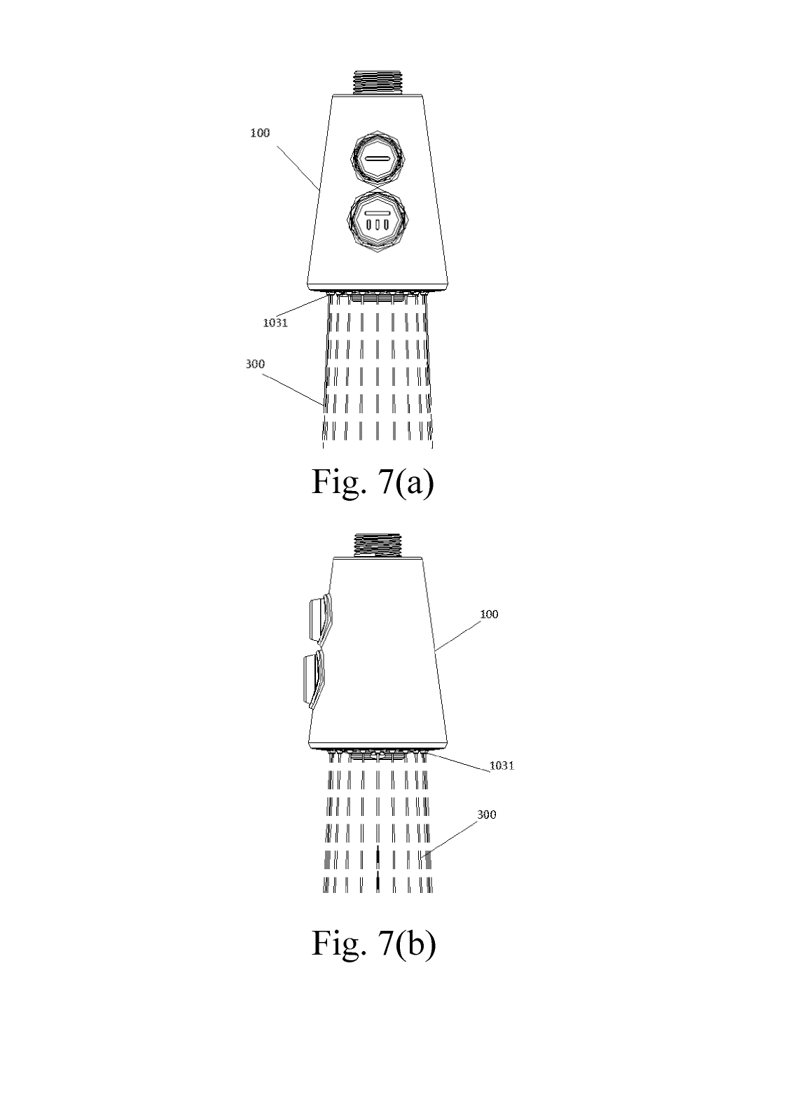

2. As shown in FIGS. 4, 7(a), 7(b), pressing down the second function switching structure, such that water in the second main water channel 107 flows into the second channel through the second water tap 1051. Then, water in the second channel flows into the first water output ring of the water output panel 103, to eject from the first water output hole 1031 into the shower water 300.

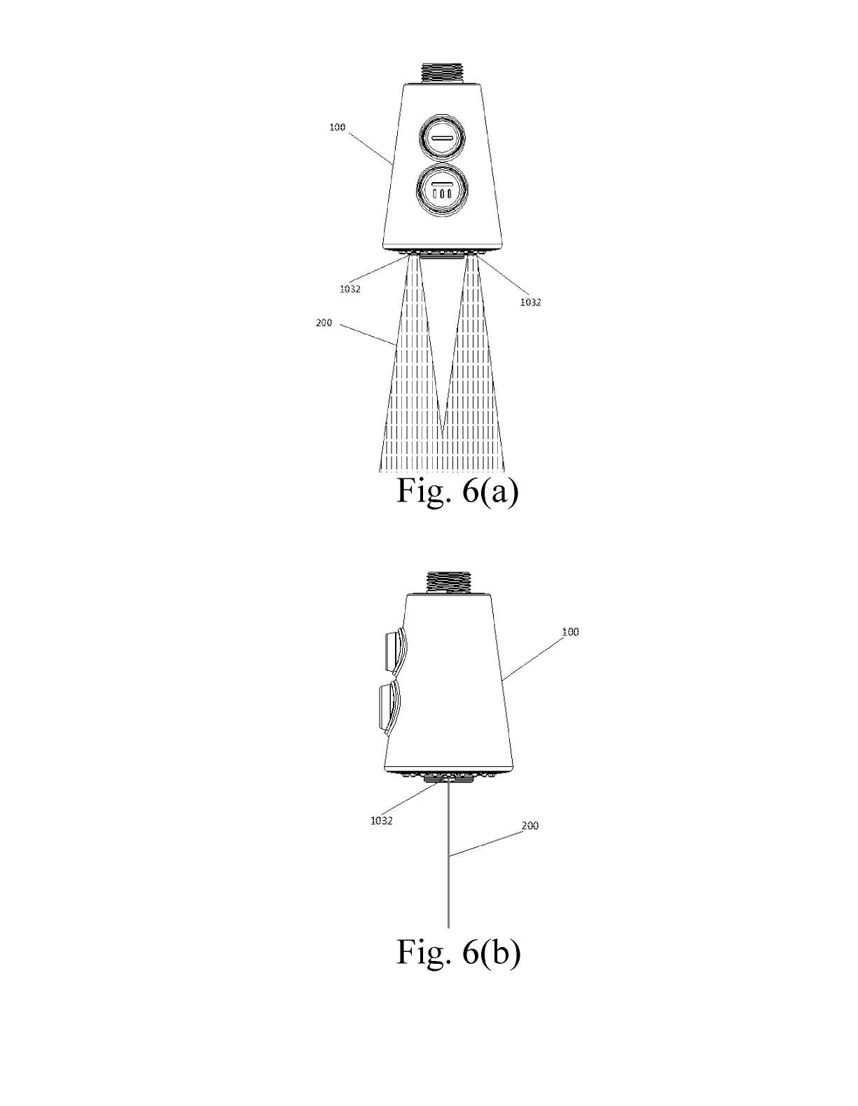

3. As shown in FIGS. 5, 6(a), 6(b), pressing down the first and second function switching structures at the same time, such that water in the first main water channel 106 flows into the second water diversion channel through the first water tap 1041, and then into the second main water channel 107. Subsequently, water in the second main water channel 107 flows into the straight channel through the second water tap 1051. Finally, water in the straight channel flows into the second water output ring of the water output panel 103, to eject from the second water output hole 1032 into flake-shape sector-contour water 200.

Compared with the prior art, the present invention has the advantages in that, it is capable of ejecting flake-shape sector-contour water, to increase water ejection area, and to realize faster and more convenient dish washing. Through providing shower water, bubble water, and flake-shape sector-contour water, the functions of the multi- function pull head can be fully realized, to meet the requirement of the user.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A multi-function pull head, comprising:
a vale seat, including:
a water input connector, disposed on a top portion of the valve seat;
an outer shell, disposed on a bottom portion of the water input connector, to protect the valve seat, and the outer shell is engaged to the water input connector through an engaging ring;
a water output portion, disposed at a lower portion of the valve seat;
a first function switching structure, disposed on the outer shell;
a second function switching structure, disposed on the outer shell; and
a water output panel, disposed at a water output end of the valve seat, on the water output panel and from its perimeter to its center is disposed a first water output ring, a second water output ring, and a third water output ring in sequence, on the first water output ring is disposed a first water output hole, on the second water output ring is disposed a second water output hole, and on the third water output ring is disposed a third water output hole, the first water output hole is a shower water output hole, used to output shower water, the second water output hole is a flake-shape sector-contour water output hole, used to output flake-shape sector-contour water, and the third water output hole is a bubble water output hole, used to output bubble water, the second water output hole 1032 is of a long strip shape, the second water output hole 1032 is disposed in a central line of the water output panel 103.

2. The multi-function pull head as claimed in claim 1, wherein two second water output holes are disposed symmetrically to each other around perimeter of the third water output hole.

3. The multi-function pull head as claimed in claim 1, wherein a plurality of first water output holes are disposed around perimeter of the water output panel with equal spacing between each other.

4. The multi-function pull head as claimed in claim 1, wherein a height of the third water output hole protruding out from the water output panel is great than the height of the second water output hole protruding out from the water output panel, and the height of the second water output hole protruding out from the water output panel is great than the height of the first water output hole protruding out from the water output panel.

5. The multi-function pull head as claimed in claim 1, wherein an opening of the second water output hole is in a plane vertical to an axial line of the valve seat.

6. The multi-function pull head as claimed in claim 5, further comprising:
a first main water channel and a second main water channel, disposed from a water input end to a water output end of the valve seat in sequence, on the first main water channel is disposed a first water diversion channel and a second water diversion channel, the first water diversion channel and a second water diversion channel are disposed at a water output end of the first main water channel, on a connection portion of the first water diversion channel, a second water diversion channel, and the first main water channel is disposed the first function switching structure, on the second main water channel is disposed a straight channel, a first channel, and a second channel, the straight channel, the first channel, and the second channel are disposed at a water output end of the second main water channel, on a connection portion of the straight channel, the first channel, the second channel, and the second main water channel is disposed the second function switching structure, the first water output hole is connected to and in communication with the first channel, the second water output hole is connected to and in communication with the straight channel, and the third water output hole is connected to and in communication with the second channel.

7. The multi-function pull head as claimed in claim 6, wherein the first function switching structure includes a first water tap, a first valve rod, and a first push button, the first push button is disposed at one end of the first water tap, and a top portion of the first valve rod is disposed at the other end of the first water tap, a bottom portion of the first valve rod is disposed in the valve seat through using a first spring.

8. The multi-function pull head as claimed in claim 7, wherein on the bottom portion of the first valve rod is disposed a plug, used for blocking the first main water channel to realize connection and communication of the respective water diversion channels when the first valve rod is moved downward, and a first tight seal ring is disposed on the plug.

9. The multi-function pull head as claimed in claim 6, wherein the second function switching structure includes a second water tap, a second valve rod, and a second push button, the second push button is disposed at one end of the second water tap, and a top portion of the second valve rod is disposed at the other end of the second water tap, a bottom portion of the second valve rod is disposed in the valve seat through using a second spring.

10. The multi-function pull head as claimed in claim 6, wherein the water input connector is connected onto the outer shell through a thread structure, and two through holes are provided on the outer shell, for the first function switching structure and second function switching structure to pass through respectively.
